(19) United States
(12) Patent Application Publication
(10) Pub. No.: US 2018/0170810 A1
(43) Pub. Date: Jun. 21, 2018

(54) Production of Magnetic Metal Nanoparticles Embedded in a Silica-Alumina Matrix

(71) Applicant: Alfed S.p.A, Milano (IT)

(72) Inventor: SERENA ESPOSITO, Torino (IT)

(21) Appl. No.: 15/128,301

(22) PCT Filed: Mar. 6, 2015
(86) PCT No.: PCT/IB2015/000302

§ 371 Date: Sep. 22, 2016

(51) Int. Cl. C04B 35/18; C01B 39/02; C22C 32/00

(52) U.S. Cl. CPC C04B 35/18; C01B 39/026; C04B 2235/5454; C04B 2235/652; C22C 32/001

(57) ABSTRACT

Nanostructured metalceramic composites with powdery consistency are disclosed, comprising nanoparticles of ferromagnetic metals (Fe, Ni, Co) dispersed in a ceramic matrix mainly based on amorphous silica and alumina as well as relevant processes for producing these materials are disclosed.

### FIELD OF THE INVENTION

The present invention relates to a process for producing metal-ceramic composite materials obtained by thermal treatments under a reducing atmosphere of zeolites previously exchanged with transition metals. In addition the present invention relates also to the metal-ceramic composite materials being the final products of said process. These materials have a powdery consistence and comprise particles of ferromagnetic metals (Fe, Ni, Co) having dimensions in the order of nanometers or tens of nanometers (hereinafter referred to as nanoparticles), dispersed in a ceramic matrix mainly consisting of amorphous silica and alumina, protecting said nanoparticles from oxidation. The contents of metal particles may be varied at the operator's will from values tending to 0% by weight (as to the lower end of the composition range) up to values of about 20-22% by weight (as to the upper end of the composition range).

### BACKGROUND OF THE INVENTION

Metal-ceramic composite materials earn a great interest in the international scientific and technological community. The main reasons justifying such interest are summarized hereinafter.

In the metal-ceramic composite materials, the ceramic matrix gives high chemical and thermal stability and protects metal particles from oxidation [1, 2]. The same metal particles should provide for opposing the major defect of the ceramic materials, namely their intrinsic brittleness. The required condition to achieve this desirable goal, is the presence of a good adhesion between the ceramic matrix and said metal particles. In such a case the catastrophic propagation of a crack starting from a defect of the ceramic matrix, is retarded by the permanent set of the metal particles forming a bridge connection between the crack faces, behind the crack front [2]. As a consequence, the crack propagation though the ceramic matrix requires a definitely higher value of the applied tension and this fact, together with the mentioned permanent set of the metal particles, causes a definite increase of the material toughness, when globally considered. Moreover, rise of the values of the ultimate tensile strength and toughness, together with the variation of the elastic properties and thermal conductivity, cause a better resistance to thermal shocks and suggest also applications in materials undergoing continuous fretting [2].

The above remarks give a so to speak traditional picture of the interest earned by the metal-ceramic composite materials in the international scientific and technologic community. Indeed since the beginning of this century, the interest earned by these materials in view of their mechanical properties, was supplemented by that connected with the magnetic properties shown by some particular metal-ceramic composite materials. In order to fully realize the reason of such interest, it is necessary to clarify the points to be discussed hereinafter.

In the frame of the metals whose particles may be dispersed in a ceramic matrix, iron (Fe), nickel (Ni) and cobalt (Co) are certainly included. These materials have a ferromagnetic behavior. Ferromagnetic particles of these metals, having a size of nanometers or tens of nanometers (hereinafter referred to as nanoparticles) find important applications in many different fields such as magnetic fluids, catalysis, biotechnologies, imaging diagnostics by magnetic resonance, data storage and environmental improvement and reclamation [3-4].

In order that use of magnetic nanoparticles in said applications is crowned with success, the following two conditions should be met, namely 1) size of nanoparticles should be lower than a critical value varying around few tens nanometers, and 2) nanoparticles should be stable in their various conditions of use.

With regard to the first condition, if respected, one may state that each nanoparticle becomes a single magnetic domain, has a superparamagnetic behavior, a constant high magnetic moment and behaves like a giant paramagnetic atom, characterized by a rapid response to the applied magnetic fields with a fully negligible magnetic retentivity and coercivity (the field required to bring magnetization to zero). These characteristics make the superparamagnetic nanoparticles extremely interesting for a wide range of applications in the biomedical field.

With regard to the second condition, it has to be noted that nanoparticles are unstable in essence in view of their extremely high surface/volume ratio. Consequently these nanoparticles spontaneously tend to agglomerate, to reduce energy associated with their extremely high specific surface. In addition nanoparticles of metals such as Fe, Ni and Co are extremely subject to oxidation in view of their negative standard reduction potentials as well as their mentioned very high specific surface. Therefore it is crucially important to set up a strategy of protecting said nanoparticles, making them stable in their condition of use. These strategies are generally based on coating said particles with various substances of organic nature such as surfactants and polymers or inorganic type such as silica (SiO₂), alumina (Al₂O₃) or carbon. It has also to be underlined that in many cases the protective shell not only provides for stabilization of nanoparticles, but may also be used for further functions required by special applications such as catalysis and bioseparation.

The above remarks clearly account for the great interest that would be earned by metal-ceramic composite materials consisting of particles of Fe, Ni, Co with sizes in the order of nanometers or tens of nanometers (hereinafter simply nanoparticles) dispersed in a matrix of amorphous silica and alumina, warranting their stability in view of its chemical inertia for a very wide range of operative conditions.

In spite of their exceptional capacity, the metal-ceramic composite materials, based either on mechanical or magnetic properties, did not yet find practical large-scale applications because of the considerable drawbacks of the production methods up to now developed. These methods will be now illustrated and briefly discussed hereinafter.

The oldest and most immediate method of producing metal-ceramic composite materials is the so-called powder metallurgy [5-7]. This consists in mixing intimately powders of ceramic materials and metals. Such a mixture is loaded into a mold and pressed. This crude specimen is then baked at the desired temperature. The conventional powder metallurgy has the following main drawbacks: 1) The homogeneous dispersion of the powders of ceramics and metal is very difficult in view of the differences of their specific weight. 2) Size of the metal particles is limited to the dimensions of the commercially available metal powders. 3) Poor adhesion between metal particles and ceramic matrix endangering the technical properties of the final product.

Another method of producing metal-ceramic composite materials comprises infiltration under pressure of molten metals in previously made porous ceramic workpieces (porous ceramic preforms) [8-9]. Also this method has serious drawbacks such as: 1) The dimensions of the metal particles are greatly limited by the pore size of the ceramic preform. 2) The amount of metal allowed to enter the preform pores is greatly limited by the poor wettability of the metals molten on said preforms; this amount may be increased only slightly by carrying out infiltration under higher pressures, but such pressures are limited by the mechanical resistance of the ceramic preform. In order to avoid incurring the drawbacks due to the low wettability of metals molten on the ceramic surfaces, the above method was modified by dipping said ceramic preforms in Fe²⁺ and Co²⁺ is effected through a hydrogen containing gaseous stream. Attainable dimensions of the metal particles thus depend on size of the preform pores, but the quantity of metal filler that can be inserted into the metal-ceramic composite is still very limited.

Another method of producing metal-ceramic composite materials consists in suspending powders of ceramic material in a concentrated solution of a cation of a transition metal containing a suitable deoxidant [12]. Therefore reduction of the transition metal cation, followed by its possible deposition onto the surface of the grains of ceramic material, occur in this solution. Then said grains are separated from the solution and undergo hot pressing, thus obtaining the product sintering. The drawbacks of this method are the little quantity of metal that can be inserted into the metal-ceramic composite and its pollution by the deoxidant of the solution.

In addition, aerogel nanocomposites based on FeCo—SiO₂ were produced by a modified sol-gel technique [10, 12-15]. However such a technique requires expensive reagents and appears to be of difficult implementation, mainly on an industrial scale, because of the intrinsic delicacy of the process.

In addition to the above mentioned main methods of producing metal-ceramic composite materials, other methods are under investigation, such as the controlled oxidation of metal alloys [16], the precipitation of metals from organic solvents on grains of ceramic materials [17] and in situ obtainment of metal particles through suitable displacement reactions [18]. These methods, in addition to the above mentioned drawbacks, require use of expensive reagents and show a difficult practical implementation, particularly on an industrial scale, on the basis of their intrinsic difficulties.

A particular attention should be given to the discussion of document EP 0260071 A2 cited as reference [19]. In principle this document relates to a subject matter similar to the present disclosure, since it deals with transformation of zeolites, previously treated with operations of ionic exchange, into metal-ceramic composite materials, through thermal treatment under reducing atmosphere, generated by a hydrogen based gaseous stream. By a careful study of this document, great and substantial differences in respect of the following description of the present invention, are however to be noted. First of all ref. [19] does not refer to metal-ceramic composite materials comprising particles of ferromagnetic metals (Fe, Ni, Co) having a size in the order of nanometers or tens of nanometers (hereinafter simply nanoparticles), dispersed in a ceramic matrix mainly based on amorphous silica and alumina, protecting said nanoparticles from oxidation, to be used for the above mentioned magnetic properties. Indeed ref. [19] refers merely and only to traditional metal-ceramic composite materials, wherein the metal particles oppose the intrinsic brittleness of the ceramic materials. Besides this substantial difference of object, in ref. [19] a number of inconsistencies and unavoidable missing actual confirmations should be noted, depriving the claims of this document of any practical utility, as clearly confirmed by the abandonment and withdrawal of the application. Only the most glaring inconsistencies will be discussed in the following paragraphs.

1) Applicants of ref. [19] claim that it is possible to obtain metal-ceramic composite materials containing up to 60% by weight of metal. This is not possible because zeolites can exchange a quantity of equivalent cations at most equal to their capacity of cationic exchange. Even when considering zeolite A that has the greatest known exchange capacity (5.48 meq/g) and cations with the highest atomic weight, and without considering the strict limitations incurred by the cationic exchange on zeolites, it would be impossible to obtain as a final product, metal-ceramic composites containing 60% by weight of metal.

2) Applicants of ref. [19] claim to be able to use zeolites exchanged with cobalt, zirconium, titanium, chrome, molybdenum, tungsten, magnesium, aluminum, rubidium, yttrium, zinc, thallium, lanthanum, cesium, iron, nickel, silver, manganese, tin, platinum, copper, strontium, lead, barium, cadmium, calcium, cerium, gold, neodymium, niobium, palladium, samarium or their mixtures, for producing metal-ceramic composite materials. With such a statement they show to ignore the properties of cationic exchange of zeolites and an insufficient knowledge of basic inorganic chemistry. Indeed zeolites exchange with great difficulty (in other words in an extremely limited or negligible quantity) with cations having an oxidation number +3 or +4. Moreover some transition elements (such as molybdenum and tungsten) can exist in aqueous solution mainly as oxyanions (in view of their amphoteric behavior), while they are extremely unstable as cations and therefore cannot be exchanged by zeolites.

3) Applicants of ref. [19] claim to obtain metal-ceramic composite materials by thermal treatments under reducing atmosphere, at temperatures between 200 and 2000° C. Perhaps temperatures of 200° C. may be compatible with reduction of cations of noble metals (Pt, Au, Ag), but this has no practical utility in view of the very high price of said metals preventing their practical use. For all other cases, these low temperatures are absolutely insufficient to obtain reduction of cations of any other metal. Moreover temperatures higher than 1500° C. cause almost any metal to melt (excepting Pt and Au whose practical use is impossible for their cost) and also melting of the ceramic matrix mainly based on amorphous silica and alumina.

4) Applicants of ref. [19] claim to be able to obtain metal-ceramic composite materials starting from zeolites exchanged with some cations of alkaline (Rb, Cs) or alkaline-earth (Mg, Ca, Sr, Ba) metals. This appears to be very complicated, or even impossible, in view of the very high trend to be present in the oxidized and not elementary state (oxidation number 0) shown by these metals, trend which is absolutely confirmed by the very negative reduction potentials. This claim appears to be very questionable and lacking of any practical meaning. Indeed on one hand metals such as Rb, Cs, Mg, Ca, Sr, Ba, whose reduction is very difficult, show an extremely high trend to become again oxidized (they should be stored under petroleum, to prevent contact with atmosphere that would immediately oxidize them again), and on the other hand these same metals have poor physic-mechanical properties (melting temperatures slightly over 100° C. and the alkaline metals are cut even by a not very sharp knife).

5) Applicants of ref. [19] claim to obtain a composite comprising particles of Fe dispersed in a ceramic matrix by a thermal treatment at 400° C. for 3 hours, under a hydrogen atmosphere at 5 kg/cm² of pressure, on a specimen of Fe exchanged zeolite A. The unlikelihood of Fe reduction at 400° C. was already discussed, and to this purpose one may also cite the results of ref. [20], showing that temperatures higher than at least 700° C. are required for this purpose. What should now be emphasized is the inconvenience of using of using pure hydrogen under pressure. Indeed use of this gas creates big safety problems on the basis of its trend to generate explosive mixtures with air in a very wide range of compositions (2 to 75% by volume). Much more appropriate would be use of mixtures H₂—Ar, at 2% by volume of H₂, free from problems of explosive mixtures.

6) Moreover Applicants of ref. [19] do not make any reference to the considerable problems arising in sintering ceramic monoliths obtained starting from zeolite precursors [21]. These problems are mainly connected with the massive generation of water and the considerable trend to shrinkage that zeolite materials undergo on heating [21]. Therefore, in view of these remarks, the results of ref. [19] do not appear to allow a practical outcome that can be evaluated in any way.

The scientific work “Metal-ceramic composite materials from zeolite precursor” by A. Marocco, G. Dell′Agli, S. Esposito, and M. Pansini, which was published on Solid State Science 14 (2012) 394-400 (hereinafter simply D1), is completely different from the disclosure of the present application. It can be said, with no fear of being belied, that the only point they have in common, is the use of a zeolite-type precursor thermally treated under a reducing atmosphere. All the remaining parts of these two disclosures deal with topics that do not have anything to do with each other, as it will be clear from the considerations that will be reported hereafter.

1) First of all the titles. The title of D1 cites generic metal-ceramic composite materials with no particular indication of the fact that the metal is in the form of particles in the nanometre range and has ferromagnetic behaviour. The title of the present application evidences clearly these two features of the produced materials.

2) D1 is centred on metal-ceramic composite materials for structural applications. Such materials exhibit technological interest on account of their mechanical properties (mechanical strength, toughness, hardness, wear and thermal shock resistance) and their possibilities of practical applications are based on them. The instant application deals with dispersions of ferromagnetic metal nanoparticles in a diamagnetic ceramic matrix. The possibilities of practical applications of such materials are related to the coupling of two materials exhibiting completely different magnetic behaviour and to the metal particles dimensions which are in the nanometre range. These two points are completely ignored in D1.

3) In D1 there was just a pale insight of the possibilities of obtaining metal-ceramic composite materials other than those for structural applications, on which D1 was based. Actually, the authors of such scientific work did not understand which kind of materials could be obtained, nor in which way. Moreover they did not understand their potential for practical applications. This statement is supported by the fact that the authors erroneously envisaged electromagnetic instead of magnetic applications (as correctly reported in this application).

4) The only proof of the production of metal-ceramic composite materials other than those for structural applications, that the authors of D1 report, is one SEM micrograph, with two different magnifications. Firstly the resolving power of SEM is not proper to reveal particles in the nanometre range. Actually, only the presence of some metal particle, with dimensions ranging between 100 and 200 nm can be revealed by this micrograph, whereas the presence of smaller metal particle can only be guessed. Unlike D1, the present application exhibits seven TEM micrographs in which Ni and Fe particles, with dimensions ranging between 5 and 30 nm, can be very clearly seen. Moreover the inventors claim to have available many other micrographs of similar materials.

5) The present invention clearly states that the “keys” for obtaining magnetic metal nanoparticles embedded in a silica-alumina matrix consist in operating as follows. Once determined the temperature at which all the cations present in the zeolite framework are reduced to 0 oxidation number, the maximum temperature of the thermal treatment under reducing atmosphere must be very slightly higher than this one. Moreover the stay at this temperature must be very short (even 0 minutes) and must be followed by a very rapid cooling up to room temperature (cooling rate higher than 10-15° C./min). The inventors justify such a way of operating, by stating that the longer the stay at temperatures higher 400° C. is, the larger the metal particles are and the larger is the extent to which the migration of metal particles to the grain surface occurs. Moreover, the present application suggests also to use rapid heating rate (higher than 10-15° C./min), in order to avoid the occurrence of detrimental, slow, reconstructive phase transformations of cation exchanged zeolites, which, if involve the transition metal cation, would make impossible its reduction to 0 oxidation number. Such way of operating must be considered an indispensable condition, lacking which magnetic metal nanoparticles embedded in a silica-alumina matrix cannot be obtained. Nothing of these basic considerations is reported in D1.

6) The only proof of the production of metal-ceramic composite materials other than those for structural applications, reported in D1, is one SEM micrograph, with two different magnifications. This SEM micrograph was taken from a compact sintered for 2 h at 800° C. under reducing atmosphere. The present application very clearly states that the metal-ceramic composite material made by magnetic metal nanoparticles dispersed in silica-alumina matrix has powdery consistence and, if monoliths of such materials are required, the use of a polymeric binder is recommended. In particular, the present application very clearly states that obtaining monoliths by sintering must absolutely be avoided, as the long-time stays at high temperatures required by sintering procedures, would unavoidably result in detrimentally enlarging the dimensions of the metal particles far beyond the nanometre range.

### OBJECT OF THE INVENTION

An object of the invention is the production of metal-ceramic composite materials with powdery consistency, comprising stable particles of ferromagnetic metals (Fe, Ni, Co) with dimensions in the order of nanometers or tens of nanometers (hereinafter simply nanoparticles), dispersed in a ceramic matrix mainly consisting of amorphous silica and alumina, protecting said nanoparticles from oxidation. The contents of metal particles may be varied at will by the operators between values tending to 0% by weight (as to the lower end of the composition range) and about 20-22% by weight (as to the upper end of the composition range). The special magnetic properties of these metal-ceramic composites predict applications in various fields, such as magnetic fluids, catalysis, biotechnologies, imaging diagnostics by magnetic resonance, data storage and environmental improvement and reclamation. Additional applications might be expected in the field of materials used to make the presence of flying aircrafts not detectable by radar systems, due to the so-called stealthiness feature.

Another object of the invention is the development of processes based on the thermal treatment under reducing atmosphere of zeolites (both commercially available and lab produced) previously exchanged with Fe, Ni and Co, allowing to achieve the products mentioned in the above paragraph in a simple and economic operative procedure.

### SUMMARY OF THE INVENTION

The first step of the process is the cationic exchange of zeolites, which may be either commercially available or laboratory sintered. Through these processes of cationic exchange, the cation originally present in zeolite (generally Na⁺) is replaced by Fe²⁺, Ni²⁺ or Co²⁺, or other cations that once reduced to an oxidation number 0, originate metals with ferromagnetic behavior. These processes are carried out by contacting zeolite with a generally hot concentrated aqueous solution of the cation to be inserted into the zeolite crystal lattice and then stirring the system. Said contact is extended for some hours, and then zeolite is separated from the solution by filtration, rinsed with distilled water and possibly is subject to additional iterations of the described process. The number of iterations increases according to the quantity of cation that should be inserted into the zeolite crystal lattice. For zeolites suitable for use in transformation into metal-ceramic composite materials (zeolite A, X, LSX, cabasite, phillipsite), seven or eight iterations are generally sufficient to reasonably approximate the maximum level of ionic exchange that can be achieved. Finally zeolite is rinsed with distilled water, dried in oven at a temperature of 80-90° C. for some hours and then stored in an environment with relative humidity of about 50% (warranted by the presence of a saturated aqueous solution of Ca(NO₃)₂.

For a clear, complete and effective understanding of the various processes leading to achieve the above mentioned final products, it is convenient beforehand to describe which are the phenomena occurring in the course of thermal treatments under reducing atmosphere (generated by the flow of a H₂ containing gaseous stream) of zeolite specimens previously exchanged with Fe, Ni, Co or other transition metals. Therefore, while temperature and time of the thermal treatment under reducing atmosphere is increased, the following phenomena occur:

1) Reduction of transition metal cations to oxidation number 0 with possible structural damage of the zeolitic lattice. It must be pointed out that even equal cations of the same transition metal, start to be reduced to the elementary state of metal at different temperatures, according to the site of the zeolitic structure where they are located [22].

2) Migration of the newly formed metal atoms to constitute metallic clusters located in the cavities of the zeolitic lattice.

3) Migration of the newly formed metal atoms outside the cavities and channels existing in the zeolitic structures, to form metal particles located on the outer surface of the zeolite grains.

4) Thermal collapse of the zeolite microporous structure.

5) Possible formation and/or crystallization of ceramic phases.

It has to be pointed out that said phenomena not always take place exactly in the above order, since they mostly overlap each other. Moreover one should also note that, once the metal particles are formed as a consequence of the reduction treatment, they the more will grow, the higher is the temperature and the longer is the time of exposition of the material to high temperatures. The last remark is due to the fact that smaller particles are intrinsically more unstable relative to bigger particles and the atomic mobility is strongly increased together with the temperature rise.

That being said, it comes out clearly the rationale of the thermal treatments under a reducing atmosphere of zeolites exchanged with Fe, Ni, Co for obtaining nanostructured metal-ceramic composites of the present invention, that will be the more valuable the smaller are the metal particles. These thermal treatments should be effected at a temperature just a little bit higher than the maximum reduction one, i.e. the temperature allowing the reduction of all cations of a given transition metal, present in any zeolite site. Once said temperature is reached, thus allowing reduction of all transition metal cation in the zeolite, the temperature must be returned to the room value in the shortest possible time, that is with the fastest possible cooling rate, in order to hinder said phenomenon of growth of the metal particles. Also in the heating stage it is advisable to use the highest possible heating rate. Indeed at temperatures even lower than those where the reduction of the transition metal cation occurs, formation and/or crystallization of various ceramic phases bay start to take place. If these phase transitions involve also the transition metal cation, its reduction will no more be possible. However it is rather easy to avoid such phase transitions, because they are generally of the reconstructional kind, thus having rather slow and complex kinetics. On the contrary, reduction reactions of the transition metal cation occur without difficulty, once the temperature of the expected reactions is reached. Therefore to prevent the detrimental phase transitions and foster the desired reduction reactions, it is sufficient to use high heating rates.

In conclusion, the characteristics of the thermal treatment of zeolites previously exchanged with Fe, Ni or Co, to obtain nanostructured metal-ceramic composites of the invention are the following:

1) Heating at the highest possible heating rate (in any case not less than 10° C./min) up to the selected temperature which should be few degrees higher (possibly no more than 10° C.) than the temperature allowing reduction of all the transition metal cation present in all sites of the zeolitic lattice.

2) Stay time at this temperature for a short interval (lower than about ten minutes) or even immediate start of the cooling phase as soon as said temperature is reached (that would mean a stay time of 0 minutes at such temperature).

3) Cooling to room temperature at the highest possible cooling rate, in any case not less than 10° C./min.

At last, as a conclusion of the description of the process to obtain the nanostructured metal-ceramic composites of the present invention, it should be pointed out that these materials have a powdery consistency. If workpieces of monolith form are required, the powder sintering process should be excluded, because the necessary thermal treatment would involve an unavoidable increase of volume of the metal particles. The production of monoliths essentially comprising particles of ferromagnetic metals (Fe, Ni, Co) having dimensions in the order of nanometers or tens of nanometers (hereinafter nanoparticles), dispersed in a ceramic matrix mainly based on amorphous silica and alumina, protecting said nanoparticles from oxidation, could anyway be easily obtained in the following way. The nanostructured metal-ceramic composite materials, produced by the above described technique, may be dispersed in any polymeric binder that is initially in a fluid state and then becomes stiff in the form that was previously imparted.

### BRIEF DESCRIPTION OF THE DRAWINGS

A concise description is now given hereinafter of the features illustrated by way of non-limiting example in the various figures of the accompanying drawings.

FIGS. 1 and 2 show the X-ray diffractograms of two specimens of nanostructured metal-ceramic composites obtained by the process described in the present application. The diffractogram of FIG. 1 relates to a specimen referenced as M, containing 15% by weight of metallic Ni. Only the diffraction peaks of metallic Ni are observed in it. These diffraction peaks are not of a high intensity and their basis appears rather wide, thus letting perceive that the size of the metal particles should be rather restrained. The absence of other diffraction peaks suggests that the ceramic matrix consists of amorphous silica and alumina. The diffractograms of all the other specimens of nanostructured metal-ceramic composites, obtained in the frame of this experimentation, arising from thermal treatments under reducing atmosphere of Ni exchanged zeolites A and X, were very similar to this illustrated in FIG. 1 and therefore were not included.

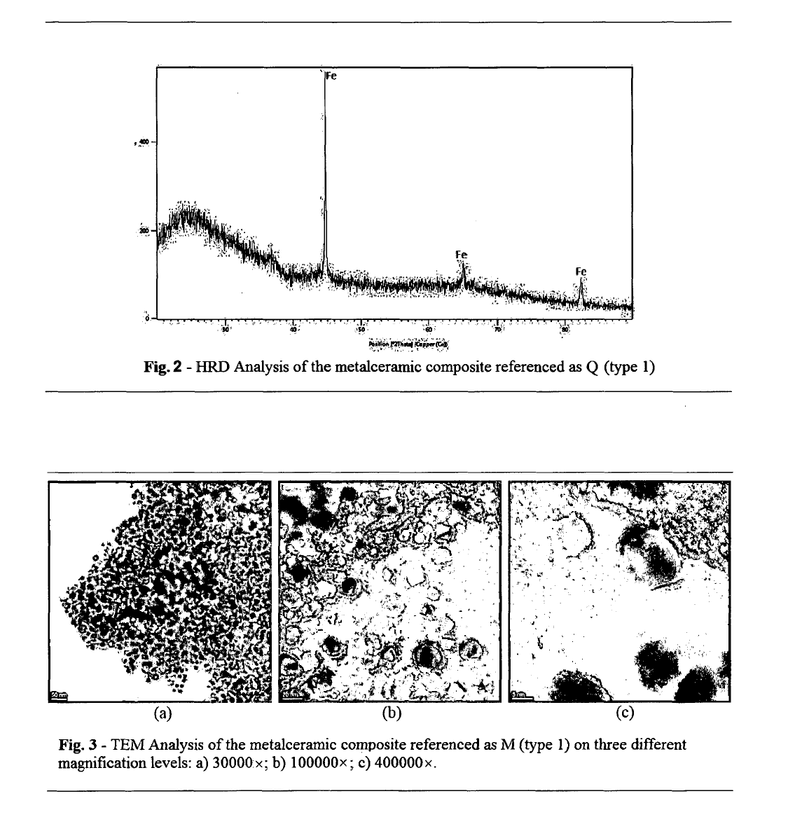

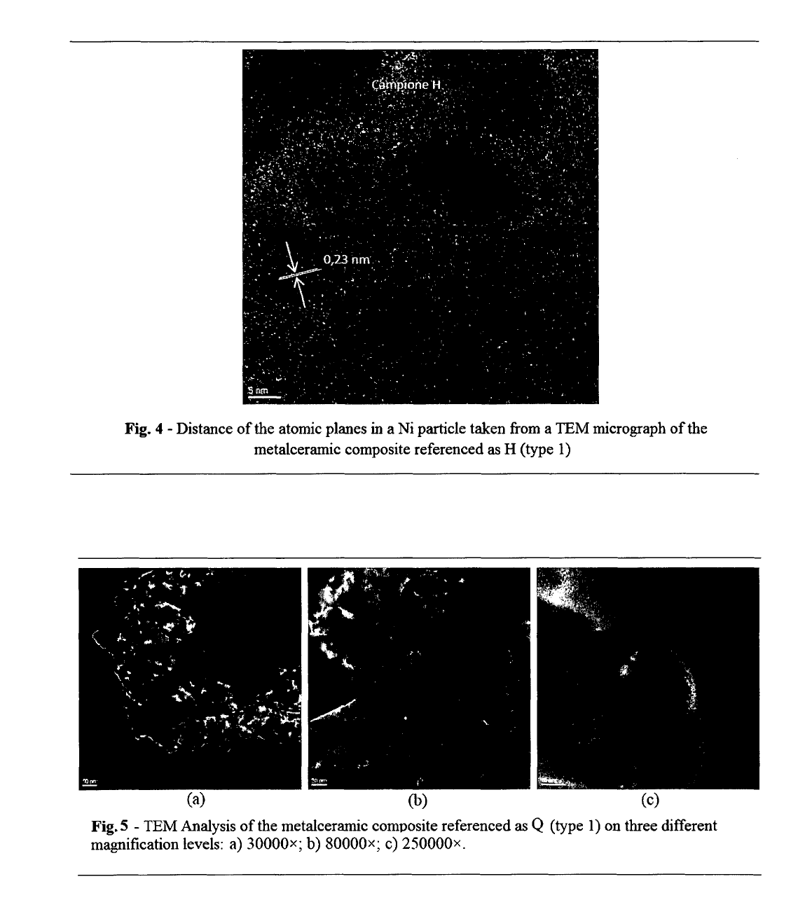

The diffractogram of FIG. 2 relates to a specimen referenced as Q, containing 17.5% by weight of metallic Fe. Only the diffraction peaks of metallic Fe are observed in it. These diffraction peaks are not of a high intensity and their basis appears rather wide, thus letting perceive that the size of the metal particles should be rather restrained. The absence of other diffraction peaks suggests that the ceramic matrix consists of amorphous silica and alumina. The diffractograms of all the other specimens of nanostructured metal-ceramic composites, obtained in the frame of this experimentation, arising from thermal treatments under reducing atmosphere of Fe exchanged zeolites A and X, were very similar to this illustrated in FIG. 2 and therefore were not included.

FIGS. 3a, 3b and 3c are TEM (transmission electronic microscopy) micrographs of the above described specimen M, taken at different magnifications. In these micrographs the Ni metal particles appear dark, while the ceramic matrix based on amorphous silica and alumina appears light.

FIG. 3a demonstrates the very high amount of existing metal particles, whose dimensions cannot be correctly assessed because of the low magnification and TEM detects not only the surface particles but also some located thereunder.

FIG. 3b taken at an intermediate magnification, demonstrates again the very high amount of Ni metal particles and allows to assess that they have dimensions between about 5 and 25 nm.

FIG. 3c taken at the maximum magnification, shows the detail of some Ni metal particles whose dimensions are in the range between 5 and 15 nm. These results appear to have an absolute value, since it was reported that the size of Ni particles, below which they behave as a single magnetic domain is 55 nm [3]. Referring again to FIG. 3c, inside Ni particles some straight striae are detected. These striae are the traces of some reticular planes of metal Ni and it is even possible to assess the interplane distance. This operation is carried out in FIG. 4, wherein the TEM image is shown of a nanostructured metal-ceramic composite references as H, containing 14.4% by weight of metal Ni. The graphic analysis of the interplane distance gives a value of about 0.23 nm, which is a value very close to those reported in literature for some Ni reticular planes.

During the experimentation forming the basis of this disclosure, other specimens of powders consisting of metal Ni nanoparticles dispersed in a matrix based on amorphous silica and alumina (starting from both zeolite A and zeolite X), the relevant TEM micrographs appear to be similar to those shown in FIGS. 3a, 3b and 3c, therefore they were not illustrated with the exception of specimen H.

FIGS. 5a, 5b and 5c are TEM (transmission electronic microscopy) micrographs of the above described specimen Q, taken at various magnifications. Also in these micrographs the metal Fe particles appear dark, while the ceramic matrix based on amorphous silica and alumina appears light.

FIG. 5a demonstrates the very high amount of existing metal particles, whose dimensions cannot be well assessed because of the low magnification and TEM detects not only the surface particles, but also some of those located under said surface.

FIG. 5b taken at an intermediate magnification level, again demonstrates the very high amount of metal Fe particles and allows to assess that they have a size between about 5 and 30 nm.

FIG. 5c taken at the maximum magnification, shows the detail of a metal Fe nanoparticle of about 25 nm. Still in FIG. 5c, some rectilinear striae are detected inside the Fe nanoparticle. These are traces of some reticular planes of metal Fe.

During the experimentation forming the basis of this disclosure, other specimens of powders consisting of metal Fe nanoparticles dispersed in a matrix based on amorphous silica and alumina (starting from both zeolite A and zeolite X), the relevant TEM micrographs appear to be similar to those shown in FIGS. 5a, 5b and 5c, therefore they were not illustrated.

### DETAILED DESCRIPTION OF THE PREFERRED EMBODIMENTS

As already pointed out in the paragraph summary of the invention, the first stage of the process for producing nanostructured metal-ceramic composites of the present disclosure consists of the ionic exchange of zeolites. Therefore this first stage will now be discussed in detail hereinafter.

The operations of cationic exchange are carried out by contacting zeolite with an aqueous solution of the cation that should enter the zeolitic lattice and stirring the system. There are various parameters controlling the cationic exchange operations, and they will be discussed one at a time as follows.

1) Concentration of the cation in the solution—When a zeolite is being contacted with an aqueous solution of a cation intended to be exchanged with that/those contained in zeolite, the system tends to a condition of chemical balance, wherein the cation originally present in zeolite (generally Na⁺) and the cation originally present in the solution spread in the solution phase and in the zeolite phase according to ratios dictated by the affinity of zeolites for the selected cations. These ratios are also affected by the lack of ideal status of the system, given by the coefficients of activity of the various elements in the various phases. In order to obtain an increase of the amount of cation to be introduced into the zeolite, it is necessary to repeat the operation of cationic exchange. In this way the solution balanced with zeolite is being replaced by a fresh solution which is not balanced with it. This procedure generally comprising 7-8 iterations, allows to approximate reasonably the maximum achievable exchange level. Higher starting concentrations of the cation may make this procedure faster and perhaps reduce the number of iterations required to achieve the desired goal. However it is to be noted that concentrations above 0.2-0.3 M appear to be a useless waste of raw materials. Indeed above said concentrations, the benefits resulting from higher starting concentrations of the cation are negligible. Thus it can be said that the operations of ionic exchange may be conducted at any starting concentration of the incoming cation, but its sensible values are in the range between 0.05 and 0.30 M.

2) Solid/Liquid (S/L) ratio—The ration between the amount of solid (zeolite) and exchange solution (liquid) should be neither too high nor too low. When there is too much solid relative to liquid (high S/L ratios), at each iteration a little amount of cation will enter the zeolite, and consequently the number of iterations will increase with equal quantity of cation entering zeolite. When there is too much liquid relative to solid (low S/L ratios), the number of final iterations required to achieve a given level of cationic exchange will be probably lower, but the amount of zeolite used for the production of metal-ceramic composites will be definitely low. On the basis of these remarks, the cationic exchange may be conducted at any S/L ratio, but the recommended range is between 1/20 and 1/200.

3) Temperature—Like most chemical reactions, also those of cationic exchange are accelerated by higher temperatures. Therefore reactions of cationic exchange at 60-70° C. allow to approximate the above cited balance condition in a shorter time, which is certainly desirable. Higher temperatures are not advisable because trend to evaporation of the exchange solution would increase too much. In some cases, such as in Fe²⁺ exchange, it is advisable to conduct the cationic exchange at low temperatures (6-7° C.) to prevent oxidation to Fe³⁺. For this purpose it is also useful to scrub Ar in the exchange solution so as to strip out oxygen that would cause oxidation to Fe³⁺.

4) Number of iterations—The value of this parameter is bound by the quantity of Fe²⁺, Ni²⁺, Co²⁺ that should be inserted into zeolite. At the above recommended values of incoming cation and S/L ratio, a number of iterations of 7-8 (in any case not above 10) allows to reach the maximum achievable exchange level, corresponding to a content up to 20-22% by weight of metal particles in the final metal-ceramic composite. Obviously a lower number of iteration will correspond to a lower final content of metal particles. Therefore the recommendation on the choice of this operative parameter is that it should be taken according to the desired content of metal particles in the final metal-ceramic composite material.

5) Type of zeolite—In principle any zeolitic material, thus having properties of cationic exchange, may be subject of the proposed processes of the present invention for the production of nanostructured metal-ceramic composite materials. In practice the most sensible choice is substantially directed to some synthetic zeolites such as zeolite A, X and LSX. Natural zeolites are indeed to be discarded as they contain various impurities that would pollute the final product. Within the synthetic zeolites it is advisable to turn to those having the highest capacity of cationic exchange, allowing to introduce higher amounts of metal particles into the zeolite and consequently in the final product of metal-ceramic composite, and showing fast exchange kinetics. Thus practically zeolites A, X and LSX.

Another reason for turning the choice of zeolites to be transformed into metal-ceramic composites, to zeolites A, X and to a lesser extent LSX, is that the synthesis methods of these zeolites (more particularly zeolites A and X) are well known and used for some time. This achieves low costs (in the order of tens of Euro cents per kilogram) of the main raw material that should be transformed into metal-ceramic composite.

However it might be interesting to use samples of synthetic cabasite or phillipsite for the production of nanostructured metal-ceramic composites of the present invention. Such zeolites, although they have an exchange capacity lower than zeolites A, X and LSX, have a more symmetric distribution of cationic sites, that could be useful to obtain particularly small nanoparticles.

It has to be underlined that in this disclosure commercial samples of zeolites A and X were used for sake of simplicity. However one can easily understand that use of samples of zeolites lab synthesized expressly for their subsequent transformation into metal-ceramic composite materials, may further improve the already obtained good results. Indeed in ref [21] the granulometric distribution of commercial samples of zeolites A and X used also for the present experimentation is reported. From this reference it can be seen that more than 90% of the zeolite grains have a size between 5 and 32 microns. In literature examples of synthesis of zeolite nanocrystals are reported, having a size lower than 100-200 nm [23-26]. It is clear that metal nanoparticles of Fe, Ni or Co which would be obtained starting from these nanocrystals of lab synthesized zeolites, would be much smaller than those obtained starting from commercial zeolites, having much bigger grains. Indeed let us suppose that all the metal (at most 20-22% by weight) contained in a 100 nm grain of zeolite, after thermal treatment under reducing atmosphere, gathers to form a single metal nanoparticle, which is the worst condition that may practically occur; considering that density of Fe, Ni or Co is about three times bigger than the density of the ceramic matrix based on amorphous silica and alumina, it results that the single metal nanoparticle takes no more than 7-8% of the 100 nm volume of the original grain; thus also the linear dimensions of such particle would be no more than some nanometers. Obviously these results would be still better if the formed metal nanoparticles are more than only one.

The sequence of operations to be carried out for obtaining the nanostructured metal-ceramic composites of the present invention as well as their basic rationale were already outlined in the paragraph Summary of the invention and will now be explained in detail as follows. Accordingly, the zeolite specimen must be heated with the fastest possible heating rate (in any case higher than 10° C./min) to a temperature which is slightly higher than the temperature at which all the cations Fe²⁺, Ni²⁺ and Co²⁺ result reduced to metal Fe, Ni and Co. Unfortunately these data are available only in some cases and for the others they should be determined experimentally by the TPR (temperature programmed reduction) method, relying upon the experience. This suggests that said temperatures are in the range of 600-1000° C. and the definition of the final temperature of the most suitable thermal treatment is a question of optimization of each production process of a determined nanostructured metal-ceramic composite. Once selected the maximum temperature to be reached during the thermal treatment under a reducing atmosphere, the time at which the maximum temperature is to be kept will be certainly of few minutes. This time may even be 0 minutes if cooling is being started at once after reaching the maximum temperature of thermal treatment under reducing atmosphere. Also the cooling step from maximum temperature to room temperature should be effected at the highest possible cooling rate. Usually this may be done by interrupting the system heating and continuing to scrub the reducing gaseous mixture of Ar and H₂ (2% vol. H₂) on the materials that were thermally treated under a reducing atmosphere.

Finally, to conclude the description of the process leading to the nanostructured metal-ceramic composites of the present invention, it has to be pointed out that the outcome is the production of materials having a powdery consistence. If the production of articles in monolith form is required, the powder sintering procedure should be excluded, because the necessary thermal treatment would involve an unavoidable increase of volume of the metal particles. The production of monoliths mainly comprising particles of ferromagnetic metals (Fe, Ni, Co) having dimensions in the order of nanometers or tens of nanometers (hereinafter indicated as nanoparticles), dispersed in a ceramic matrix mainly based on amorphous silica and alumina, protecting said nanoparticles from oxidation, may in any case be easily obtained by dispersing the so obtained nanostructured metal-ceramic composites in any initially fluid polymeric binder that subsequently becomes stiff in the form previously imparted to it. The paragraph Object of the invention mentions the obtained nanostructured metal-ceramic materials.

### EXAMPLES

The following examples illustrate the samples of nanostructured composite materials obtained through the methods reported in the present disclosure, together with the detailed description of the procedures required for their achievement.

Sample G

Preparation: A sample of commercial zeolite A was contacted with a 0.2 M aqueous solution of NiCl₂.6H₂O in a solid/liquid ratio 1/20 at a temperature of about 60-70° C. The contact lasted about six hours and was iterated ten times. This sample of Ni exchanged zeolite A, resulted to have a content of Ni revealed by its equivalent fraction x_{Ni}=0.75, was heated under reducing atmosphere (generated by a flow of a gaseous mixture Ar—H₂ at 2% volume of the latter) at a rate of 15° C./min up to 735° C., it was kept at this temperature for 10 minutes and subsequently let cool up to room temperature in the closed and off oven.

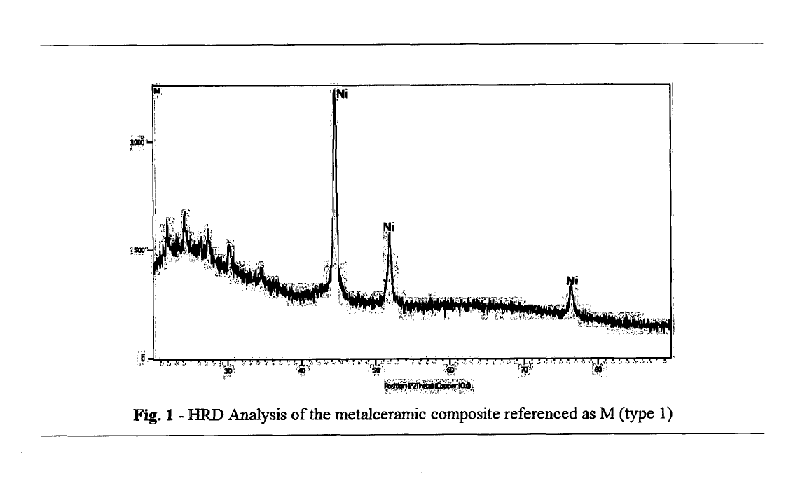

The diffractogram of the so obtained sample, which resulted to have a content of metal Ni of 15% by weight, is very similar to that shown in FIG. 1, this indicating that the sample consists of particles of metal Ni dispersed in a matrix based on amorphous silica and alumina. The TEM micrographs of this sample are similar to those shown in FIGS. 3a, 3b and 3c, indicating that the nanoparticles of metal Ni have a size between 5 and 25 nm.

Sample H

Preparation: A sample of commercial zeolite X was contacted with a 0.2 M aqueous solution of NiCl₂.6H₂O in a solid/liquid ratio 1/20 at a temperature of about 60-70° C. The contact lasted about six hours and was iterated six times. This sample of Ni exchanged zeolite X, resulted to have a content of Ni revealed by its equivalent fraction x_{Ni}=0.79, was heated under reducing atmosphere (generated by a flow of gaseous mixture Ar—H₂ at 2% volume of the latter) at a rate of 15° C./min up to 735° C., it was kept at this temperature for 10 minutes and subsequently let cool up to room temperature in the closed and off oven.

The diffractogram of the so obtained sample, which resulted to have a content of metal Ni of 14.4% by weight, is very similar to that shown in FIG. 1, this indicating that the sample consists of particles of metal Ni dispersed in a matrix based on amorphous silica and alumina. The TEM micrographs of this sample are similar to those shown in FIGS. 3a, 3b and 3c, indicating that the nanoparticles of metal Ni have a size between 5 and 25 nm.

Sample I

Preparation: A sample of commercial zeolite A was contacted with a 0.2 M aqueous solution of NiCl₂.6H₂O in a solid/liquid ratio 1/20 at a temperature of about 60-70° C. The contact lasted about six hours and was iterated ten times. This sample of Ni exchanged zeolite A, resulted to have a content of Ni revealed by its equivalent fraction x_{Ni}=0.75, was heated under reducing atmosphere (generated by a flow of gaseous mixture Ar—H₂ at 2% volume of the latter) at a rate of 15° C./min up to 750° C., it was kept at this temperature for 15 minutes and subsequently let cool up to room temperature in the closed and off oven.

The diffractogram of the so obtained sample, which resulted to have a content of metal Ni of 15.0% by weight, is very similar to that shown in FIG. 1, this indicating that the sample consists of particles of metal Ni dispersed in a matrix based on amorphous silica and alumina. The TEM micrographs of this sample are similar to those shown in FIGS. 3a, 3b and 3c, indicating that the nanoparticles of metal Ni have a size between 5 and 25 nm.

Sample L

Preparation: A sample of commercial zeolite X was contacted with a 0.2 M aqueous solution of NiCl₂.6H₂O in a solid/liquid ratio 1/20 at a temperature of about 60-70° C. The contact lasted about six hours and was iterated six times. This sample of Ni exchanged zeolite X, resulted to have a content of Ni revealed by its equivalent fraction x_{Ni}=0.79, was heated under reducing atmosphere (generated by a flow of gaseous mixture Ar—H₂ at 2% volume of the latter) at a rate of 15° C./min up to 750° C., it was kept at this temperature for 15 minutes and subsequently let cool up to room temperature in the closed and off oven.

The diffractogram of the so obtained sample, which resulted to have a content of metal Ni of 14.4% by weight, is very similar to that shown in FIG. 1, this indicating that the sample consists of particles pf metal Ni dispersed in a matrix based on amorphous silica and alumina. The TEM micrographs of this sample are similar to those shown in FIGS. 3a, 3b and 3c, indicating that the nanoparticles of metal Ni have a size between 5 and 25 nm.

Sample M

Preparation: A sample of commercial zeolite A was contacted with a 0.2 M aqueous solution of NiCl₂.6H₂O in a solid/liquid ratio 1/20 at a temperature of about 60-70° C. The contact lasted about six hours and was iterated ten times. This sample of Ni exchanged zeolite A, resulted to have a content of Ni revealed by its equivalent fraction x_{Ni}=0.75, was heated under reducing atmosphere (generated by a flow of gaseous mixture Ar—H₂ at 2% volume of the latter) at a rate of 15° C./min up to 750° C. and then was let cool up to room temperature in the closed and off oven (time of thermal treatment at 750° C. equal to 0 minutes).

The diffractogram and the TEM micrographs of the so obtained sample, which resulted to have a content of metal Ni of 15% by weight, are reported in FIG. 1 and FIG. 3, respectively. This indicates that the sample consists of nanoparticles of metal Ni dispersed in a matrix based on amorphous silica and alumina and that these nanoparticles of metal Ni have a size between 5 and 25 nm.

Sample N

Preparation: A sample of commercial zeolite X was contacted with a 0.2 M aqueous solution of NiCl₂.6H₂O in a solid/liquid ratio 1/20 at a temperature of about 60-70° C.: The contact lasted about six hours and was iterated six times. This sample of Ni exchanged zeolite X, resulted to have a content of Ni revealed by its equivalent fraction x_{Ni}=0.79, was heated under reducing atmosphere (generated by a flow of gaseous mixture Ar—H₂ at 2% volume of the latter) at a rate of 15° C./min up to 750° C. and then was let cool up to room temperature in the closed and off oven (time of thermal treatment at 750° C. equal to 0 minutes).

The diffractogram of the so obtained sample, which resulted to have a content of metal Ni of 14.4% by weight, is very similar to that reported in FIG. 2, this indicating that the sample consists of particles of metal Ni dispersed in a matrix based on amorphous silica and alumina. The TEM micrographs of this sample are similar to those reported in FIGS. 3a, 3b and 3c, thus indicating that the nanoparticles of metal Ni have a size between 5 and 25 nm.

Sample O

Preparation: A sample of commercial zeolite A was contacted with a 0.1 M aqueous solution of FeSO₄.7H₂O in a solid/liquid ratio of 1/50. To avoid oxidation of Fe²⁺ to Fe³⁺, the exchange was conducted at 7° C. and in the aqueous solution of Fe²⁺, Ar was continuously scrubbed. The contact lasted about six hours and was iterated ten times. This sample of Fe exchanged zeolite A, resulted to have a content of Fe revealed by its equivalent fraction x_{Fe}=0.92, was heated under reducing atmosphere (generated by a flow of gaseous mixture Ar—H₂ at 2% volume of the latter) at a rate of 15° C./min up to 800° C., was kept at this temperature for 30 minutes and then was let cool up to room temperature in the closed and off oven.

The diffractogram of the so obtained sample, which resulted to have a content of metal Fe of 17.5% by weight, is very similar to that reported in FIG. 2, this indicating that the sample consists of particles of metal Fe dispersed in a matrix based on amorphous silica and alumina. The TEM micrographs of this sample are similar to those reported in FIGS. 5a, 5b and 5c, thus indicating that the nanoparticles of metal Fe have a size between 5 and 30 nm.

Sample P

Preparation: A sample of commercial zeolite X was contacted with a 0.1 M aqueous solution of FeSO₄.7H₂O in a solid/liquid ratio of 1/50. To avoid oxidation of Fe²⁺ to Fe³⁺, the exchange was conducted at 7° C. and in the aqueous solution of Fe²⁺, Ar was continuously scrubbed. The contact lasted about six hours and was iterated eight times. This sample of Fe exchanged zeolite X, resulted to have a content of Fe revealed by its equivalent fraction x_{Fe}=0.82, was heated under reducing atmosphere (generated by a flow of gaseous mixture Ar—H₂ at 2% volume of the latter) at a rate of 15° C./min up to 800° C., was kept at this temperature for 30 minutes and then was let cool up to room temperature in the closed and off oven.

The diffractogram of the so obtained sample, which resulted to have a content of metal Fe of 14.3% by weight, is very similar to that reported in FIG. 2, this indicating that the sample consists of particles of metal Fe dispersed in a matrix based on amorphous silica and alumina. The TEM micrographs of this sample are very similar to those reported in FIGS. 5a, 5b and 5c, thus indicating that the nanoparticles of metal Fe have a size between 5 and 30 nm.

Sample Q

Preparation: A sample of commercial zeolite A was contacted with a 0.1M aqueous solution of FeSO₄.7H₂O in a solid/liquid ratio of 1/50. To avoid oxidation of Fe²⁺ to Fe³⁺, the exchange was conducted at 7° C. and in the aqueous solution of Fe²⁺, Ar was continuously scrubbed. The contact lasted about six hours and was iterated ten times. This sample of Fe exchanged zeolite A, resulted to have a content of Fe revealed by its equivalent fraction x_{Fe}=0.92, was heated under reducing atmosphere (generated by a flow of gaseous mixture Ar—H₂ at 2% volume of the latter) at a rate of 15° C./min up to 800° C. and subsequently was let cool up to room temperature in the closed and off oven (time of thermal treatment at 800° C. equal to 0 minutes).

The diffractogram and the TEM micrographs of the so obtained sample, which resulted to have a content of metal Fe of 17.5% by weight, are reported in FIG. 2 and FIG. 5, respectively. This indicates that the sample consists of nanoparticles of metal Fe dispersed in a matrix based on amorphous silica and alumina, and these nanoparticles of metal Fe have a size between 5 and 30 nm.

Sample R

Preparation: A sample of commercial zeolite X was contacted with a 0.1 M aqueous solution of FeSO₄.7H₂O in a solid/liquid ratio of 1/50. To avoid oxidation of Fe²⁺ to Fe³⁺, the exchange was conducted at 7° C. and in the aqueous solution of Fe²⁺, Ar was continuously scrubbed. The contact lasted about six hours and was iterated eight times. This sample of Fe exchanged zeolite X, resulted to have a content of Fe revealed by its equivalent fraction x_{Fe}=0.82, was heated under reducing atmosphere (generated by a flow of gaseous mixture Ar—H₂ at 2% volume of the latter) at a rate of 15° C./min up to 800° C. and subsequently was let cool up to room temperature in the closed and off oven (time of thermal treatment at 800° C. equal to 0 minutes).

The diffractogram of the so obtained sample, which resulted to have a content of metal Fe of 14.3% by weight, is very similar to that shown in FIG. 2, and this indicates that the sample consists of particles of metal Fe dispersed in a matrix based on amorphous silica and alumina. The TEM micrographs of this sample are very similar to those reported in FIGS. 5a, 5b and 5c, thus indicating that the nanoparticles of metal Fe have a size between 5 and 30 nm.

### INDUSTRIAL APPLICABILITY

As already stated in the preceding paragraphs, the international scientific and technologic community show a great interest for the materials consisting of magnetic nanoparticles covered by a ceramic matrix protecting them from oxidation, thus making the particles stable. This interest is justified by the various applications that said materials may have in the following sector: magnetic fluids, catalysis, biotechnologies/biomedicine/bioengineering, diagnostics by magnetic resonance, data storage and environmental improvement and reclamation, production of stealth aircrafts, whose flight cannot be detected by radar systems. In the frame of these applications, that appearing particularly appealing and probably having the widest and immediate prospect of success, is the field of biotechnologies, biomedicine and bioengineering. Indeed in these sectors, research based on use of magnetic nanoparticles stabilized in various ways, is particularly active and comprises the following topics: electrochemical biosensors, detection and separation with purification of biomolecules (nucleic acids and proteins) and cells, targeted delivery of genes and drugs to highly selected organic regions, regeneration of biological tissues, detoxication of biological fluids and magnetic hyperthermia. Use of conditional in predicting such applications is justified by the following considerations. Although on the one hand application of magnetic nanoparticles in biotechnologies is already a reality, such as their use in the human genome project for DNA purification, on the other hand just the difficulty of obtaining reliable and stable magnetic nanoparticles is a restraint to their massive application. In view of this, the implementation of a simple, reliable and economic technique like that disclosed by the present invention, might give a great boost to applications in the above mentioned fields. On the basis of these considerations, products obtained by the processes disclosed in the present invention might reasonably and probably find application in the above mentioned fields.

Although the present invention was described as an illustrative but non limiting example through its preferred embodiments, it has to be understood that variations and/or modifications may be resorted hereto, without departing however from its scope of protection, as defined in the appended claims.

### LITERATURE REFERENCES

1 S. Moya, S. Lopez-Esteban, C. Pecharroman, Prog. Mater. Sci. 52 (2007) 1017-1090.
2 J. A. Yeomans, J. Eur. Ceram. Soc. 28 (2008)1543-1550.
3 A. H. Lu, E. L. Salabas, F. Schüth, Ang. Chem. Int. Ed. 46 (2007) 1222-1244.
4 I. M. Hsing, Y. Xu, W. Zhao, Electroanalysis 19 (2007) 755-768.
5 E. Bernardo, G. Scarinci, S. Hreglich, J. Eur. Ceram. Soc. 23 (2003) 819-1827.
6 S. T. Oh, T. Sekino, K. Niihara, J. Eur. Ceram. Soc. 18 (1998) 31-37.
7 M. Szafran, K. Konopka, E. Bobrick, K. Kurzydlowski, J. Eur. Ceram. Soc. 27 (2007) 651-654.
8 S. Skirl, M. Hoffman, K. Bowmann, S. Wiederhorn, J. Rodel, Acta Mater. 46 (1998) 2493-2499.
9 G. Krauss, J. Kubler, E. Trentini, Mater. Sci. Eng. A 337 (2002) 315-322.
10 S. Costacurta, I. Malfatti, P. Innocenzi, H. Amenitsch, A. Masili et al., Micr. Mes. Mat. 115 (2008) 338-340.
11 V. Vendange, E. Troc, P. Colomban, J. Sol-Gel Sci. Tech. 11 (1998) 299-307.
12 L. P. Huang, J. Li, Compos. Part A, 30 (1999) 615-618.
13 A. Corrias, M. F. Casula, A. Falqui, G. Paschina, Chem. Mater. 16 (2004) 3130-3138.
14 D. Carta, G. Mountjoy, M. Gass, G. Navarra, M. F: Casula, A. Corrias, J. Chem. Phys. 137 (2007) 204705 1-9.
15 A. Casu, M. F. Casula, A. Corrias, A. Falqui, D. Loche, et al., Phys. Chem. Chem. Phys. 10 (2008) 1043-1052.
16 B. S. S. Daniel, V. S. R. Murthy, G. S. Murty, J. Process. Mater. Technol. 68 (1997) 132-155.
17 J. A. Haber, N. V. Gunda, V. E. Buhro, J. Aerosol Sci. 29 (1998) 637-645.
18 M. Pavese, P. Fino, M. Valle, C. Badini, Compos. Sci. Technol. 66 (2006) 350-356.
19 J. Nobuo, I. Tsutomu, I. Hyroyuki, N. Masayoshi, European Patent 0 260 071 A2, (1988).
20 S. Ronchetti, E. A. Turcato, A. Delmastro, S. Esposito, Claudio Ferone, M. Pansini, B. Onida, D. Mazza Mat. Res. Bull. 45 (2010) 744-750.
21 A. Marocco, S. Esposito, G. Dell′Agli, M. Pansini, J. Eur. Ceram. Soc. 31 (2011) 1965-1973.
22 A. Luengnaruemitchai, A. Kaengsilalai, Chem. Eng. Journal 144 (2008) 96-102.
23 G. Zhu, S. Qiu, J. Yu, Y. Sakamoto, F. Xiao, R. Xu, O. Terasaki, Chem. Mater. 10, (1998), 1483-1486.
24 P. S. Singh, J. W. White, Phys. Chem. Chem. Phys. 1 (1999) 4131-4138.
25 S. Mintova, N. H. Olson, V. Valtchev, T. Bein, Science 283 (1999) 958-960.
26 R. A. Rakoczy, Y. Traa Micr. Mes. Mat. 60 (2003) 69-78.

1. A nanostructured metalceramic composite with powdery consistency, comprising nanoparticles of ferromagnetic metals (Fe, Ni, Co) having dimensions in the order of nanometers or tens nanometers, dispersed in a ceramic matrix mainly based on amorphous silica and alumina protecting said nanoparticles from oxidation.

2. The nanostructured metalceramic composite according to claim 1, containing a variable quantity between 0 and 22% by weight of metallic Fe, Ni and Co.

3. The nanostructured metalceramic composite according to claim 1, wherein the raw material for the ceramic matrix comprises zeolites of the type A, X, LSX, chabazite and phillipsite.

4. The nanostructured metalceramic composite according to claim 1, wherein the raw material for the ceramic matrix comprises any other zeolitic material, such as microporous or mesoporous material consisting of atoms of Si, Al or other species, tetrahedrally coordinated, sharing the O atoms at the tetrahedron corners and having ion exchange properties.

5. The nanostructured metalceramic composite according to claim 1, wherein the raw material for the ceramic matrix comprises nanocrystals of zeolites, having dimensions of tens or hundreds nanometers, obtained in laboratory by proper synthesis in processes of commercially available zeolites.

6. A process for producing nanostructured metalceramic composites with powdery consistency according to claim 1, wherein the dispersion of nanoparticles of ferromagnetic metals in the ceramic matrix is carried out by thermal treatments in a reducing environment of zeolites previously exchanged with Fe, Ni or Co.

7. The process for producing metalceramic composites according to claim 6, wherein the thermal treatments are carried out at a temperature between 600 and 1000° C. with a short stay time at the maximum temperature and rapid heating and cooling velocities.

8. A process for producing monoliths starting from nanostructured metal-ceramic composites produced according to claim 6, wherein such nanostructured metal-ceramic composite is dispersed in any polymeric binder that is initially fluid and then becomes stiff in the previously imparted shape.
